(19) United States
(12) Patent Application Publication
(10) Pub. No.: US 2022/0330571 A1
(43) Pub. Date: Oct. 20, 2022

(54) FIELD BEAN PROTEIN COMPOSITION

(71) Applicant: ROQUETTE FRERES, LESTREM (FR)

(72) Inventors: Damien PASSE, DOUAI (FR); Christophe LAROCHE, FOUGERES (FR); Jorge Luis VENTUREIRA, LILLE (FR)

(21) Appl. No.: 17/593,607

(22) PCT Filed: Mar. 25, 2020
(86) PCT No.: PCT/EP2020/058441

§ 371 Date: Sep. 21, 2021

(30) Foreign Application Priority Data
Mar. 25, 2019 (FR) 1903100

(51) Int. Cl. A23J 1/14; A23J 3/14; A23L 33/185

(52) U.S. Cl. CPC A23J 1/14; A23J 3/14; A23L 33/185

(57) ABSTRACT

The invention relates to the field of plant protein isolates, and in particular to field bean protein isolates and such an isolate, the solubility of which is less than 25% at a minimum pH of 7. The invention also relates to a method for the production thereof and to industrial applications thereof.

### TECHNICAL FIELD

The invention relates to the field of plant protein isolates, and in particular to field bean protein isolates.

### BACKGROUND ART

Field beans, or faba beans, are annual plants of the Vicia faba species. These are leguminous plants of the Fabaceae family, Faboideae subfamily, Fabeae tribe.

This is the same species as the broad bean, a plant that has been used for human consumption since ancient times. The word bean thus refers to both the seed and the plant.

Several production methods are known in the background art for producing a protein isolate from field bean seeds.

“Potential of Fava Bean as future protein supply to partially replace meat intake in the human diet.” (Multari & al., in Comprehensive Reviews in Food Science and Food Safety Vol. 14, 2015) offers an excellent review of current knowledge on this subject.

The conventional method starts with grinding the field beans in order to obtain a flour. This flour is then diluted in water in order to undergo an alkaline extraction aimed at solubilizing the field bean proteins. The solution then undergoes a liquid/solid separation in order to obtain a crude protein solution and a solid fraction enriched with starch and fiber. The proteins are extracted via precipitation at isoelectric pH of the proteins, they are separated from the aqueous solution and dried.

The protein isolate thus obtained has a protein content of at least 80% (expressed as total nitrogen multiplied by the coefficient 6.25, on the total dry matter, calculation method disclosed in the document available at the following address: http://www.favv-afsca.fgov.be/laboratories/methods/fasfc/_documents/METLFSAL003Proteinebrutev10.pdf). This isolate has been known to be of industrial interest for a long time, especially in human and animal nutrition. Indeed, its nutritional and functional properties allow it to be included in a large number of recipes and formulations.

However, two major technical problems remain which a skilled person must still face today.

First of all, the protein isolate obtained is systematically characterized by a dark gray, or even black, color. This comes mostly from the tannins and polyphenols present in the external fibers, extracted along with the proteins during the method for manufacturing said protein isolate.

Despite taking extreme care, conventional methods for dehulling the external fiber do not allow enough tannins and polyphenols to be removed, and the apparent dark color limits the number of possible uses.

Optimized methods have been developed. The method disclosed for example in “Technological-scale dehulling process to improve the nutritional value of faba beans” (Meijer & al., in Animal Feed Science and Technology, 46, 1994) includes two grinding steps, two filtering steps and a turbo-separation (classification of particles according to their density using an ascending air flow). These technological refinements are complex and thus costly.

Secondly, the field bean protein isolate according to the background art has an excellent aqueous solubility, in particular at pH values above 7. This property, which is essential for certain applications, is a disadvantage for others, such as for example in bakery/pastry applications.

In his thesis “THE EFFECT OF GENOTYPE AND THE ENVIRONMENT ON THE PHYSICOCHEMICAL AND FUNCTIONAL ATTRIBUTES OF FABA BEAN PROTEIN ISOLATES” in 2015, Singhal exemplifies very precisely this excellent solubility. The method is conventional in the production of field bean protein isolate, combining alkaline extraction and isoelectric precipitation. The author then focuses on the functional characterization of this isolate, including its solubility. Measured at pH 7, according to the methodology used in “Emulsifying properties of chickpea, faba bean, lentil and pea proteins produced by isoelectric precipitation and salt extraction.” (Food Research International, 44, 2011, p. 2742-2750), it is clearly higher than 60%

There are several solutions including the one previously presented in the application EP 2,911,524. This solution consists mainly of the use of lime as a pH rectification agent. The calcium ion with its two positive charges acts as a cross-linking agent, which will link the different protein chains together and thus create a structure the solubility of which is reduced compared to the same structure that was not treated with lime.

Nevertheless, this solution warrants the compulsory use of lime, a compound which remains difficult to implement in industrial settings. Indeed, it is very insoluble and is thus handled in the form of milky suspension. Industrial installations are frequently clogged by deposits, leading to stopping and cleaning.

It is therefore technically interesting to know a simple and effective method that makes it possible to obtain a field bean isolate with the lightest possible color and having a reduced solubility at pH values greater than 7.

The applicant deserves recognition for having found such a method and such an isolate. This invention will be disclosed in the following section.

### DESCRIPTION OF THE INVENTION

According to the present invention, a field bean protein composition is proposed, the color of which is characterized by a component L greater than 70 according to the measurement L*a*b and the solubility is less than 25% at pH values greater than 7. The preferred solubility at pH values greater than or equal to 7 is less than 25%. Even more preferably, the solubility at pH 3 is also less than 25%.

According to another aspect, method for producing a field bean protein composition according to the invention is proposed, characterized in that it comprises the following steps: 1) Using field bean seeds; 2) Grinding the field bean seeds by means of a stone mill, followed by separating the obtained ground material into two fractions referred to as light and heavy by means of an ascending air flow, followed by a second grinding of the heavy fraction with a knife mill; 3) Finally grinding the heavy fraction by means of a roller mill to obtain a flour; 4) Suspending the flour in an aqueous solvent with a pH of between 6 and 8, preferably 7; 5) Removing the dry matter fractions from the suspension by centrifugation and obtaining a liquid fraction; 6) Isolating by precipitation by heating at the isoelectric pH of the field bean proteins contained in the liquid fraction; 7) Diluting the field bean proteins previously obtained to 15-20% by weight of dry matter and neutralizing the pH between 5.5 and 6.5, preferably 6.5, to obtain the field bean protein composition; 8) Drying the field bean protein composition.

According to a final aspect, the industrial uses, in particular in human or animal nutrition, in cosmetics, in pharmacy, of the field bean protein isolate according to the invention are proposed.

The invention and the variants thereof can make it possible, typically, to propose a practical and efficient solution for meeting the needs of the industry to have a field bean protein isolate the color of which is characterized by a component L greater than 70 according to the measurement L*a*b and the solubility at pH values greater than 7 is less than 25%, the method for producing same and the ideal industrial uses thereof.

The invention will be better understood with the aid of the description presented in the following chapters.

### BRIEF DESCRIPTION OF THE DRAWINGS

Other features, details and advantages of the invention will appear from reading the following detailed description, and by analyzing the appended drawings in which:

FIG. 1

FIG. 1 shows a conventional method for separating the external fibers and the cotyledons of field beans;

FIG. 2

FIG. 2 shows a method according to the invention for separating the external fibers and the cotyledons of field bean seeds;

### DETAILED DESCRIPTION OF THE INVENTION

As mentioned above, according to the present invention, a field bean protein composition is proposed, the color of which is characterized by a component L greater than 70, preferably greater than 75, even more preferably greater than 80 according to the measurement L*a*b and the solubility according to test A is less than 25% at pH values greater than 7.

Preferably, the solubility of the field bean protein composition according to the invention according to test A at pH values greater than or equal to 7 is less than 25% of the total weight.

Even more preferably, the solubility of the field bean protein composition according to the invention according to test A at pH values greater than or equal to 7 and less than or equal to 8 is less than 25% of the total weight.

According to another particular embodiment, the solubility of the field bean protein composition according to the invention according to test A at pH 3 is less than 25% of the total weight.

“Field bean” is intended to mean the group of annual plants of the species Vicia faba, belonging to the group of leguminous plants of the family Fabaceae, subfamily Faboideae, tribe Fabeae. A distinction is made between Minor and Major varieties. In the present invention, wild-type varieties and those obtained by genetic engineering or varietal selection are all excellent sources.

“Protein composition” is understood to mean any protein-rich composition, obtained by extraction of a plant and purification if need be. A distinction is made between the concentrates in which the richness expressed as a % by weight of proteins to dry matter is greater than 50%, and the isolates in which the richness expressed as a % by weight of proteins to dry matter is greater than 80%.

“Measurement L*a*b” is understood to mean the evaluation of the coloring according to the chromatic space methodology of the CIE (International Commission on Illumination) presented in the publication “Colorimetry” (no. 15, 2nd edition, page 36, 1986), by means of a suitable spectrophotometer, which converts it into 3 parameters: the lightness L, which takes values between 0 (black) and 100 (reference white); the parameter a represents the value on a green→red axis and the parameter b represents the value on a blue→yellow axis. The measurement of this coloring is preferentially performed using the spectrophotometers DATA COLOR-DATA FLASH 100 or KONIKA MINOLTA CM5, with the aid of their user manuals.

“Solubility” is understood to mean the quantification of the percentage of water-soluble material in a powder by diluting the powder in distilled water, centrifuging the resulting suspension and analyzing the amount of solubilized material in the supernatant, measurable by the following test A:

150 g of distilled water are introduced into a 400 ml beaker at 20° C.+/−2° C. by stirring with a magnetic stirrer bar, and precisely 5 g of legume protein sample to be tested are added. If required, the pH is adjusted to the desired value with 0.1 N NaOH. The content is supplemented with water to reach 200 g of water. Mixing is carried out for 30 minutes at 1000 rpm and centrifugation is carried out for 15 minutes at 3000 g. 25 g of the supernatant are collected and introduced into a crystallizing dish dried and tared beforehand. The crystallizing dish is placed in an oven at 103° C.+/−2° C. for 1 hour. It is then placed in a desiccator (with desiccant) to cool to ambient temperature, and is weighed.

The solubility corresponds to the content of soluble dry matter, expressed as % by weight relative to the weight of the sample. The solubility is calculated with the following formula:

$$\% solubility = \frac{( m 1 - m 2 ) \times ( 200 + P )}{P 1 \times P} \times 100 \qquad [ Math . 1 ]$$

where:
P=weight, in g, of the sample=5 g
m1=weight, in g, of the crystallizing dish after drying
m2=weight, in g, of the empty crystallizing dish
P1=weight, in g, of the sample collected=25 g

Preferably, the isolate according to the invention is characterized in that its protein content is greater than 70% by weight, preferably greater than 80% by weight, expressed as a percentage of protein on dry matter, even more preferably greater than 90% by weight.

Preferably, the protein composition according to the invention has a dry matter content greater than 80% by weight, preferably greater than 85% by weight, even more preferably greater than 90% by weight. Any method for measuring water content can be used to quantify this dry matter, the gravimetric technique evaluating water loss through drying being preferred. It consists in determining the amount of water evaporated by heating a known amount of a sample of known weight.
The sample is first weighed and a mass m1 is measured in grams.
The water is evaporated off by placing the sample in a heated chamber until the mass of the sample has stabilized, the water being completely evaporated off. Preferably, the temperature is 105° C. at atmospheric pressure.
The final sample is weighed and a mass m2 is measured in grams.
Solids=(m2/m1)*100.

A second aspect of the invention consists of a method for producing a field bean protein composition according to the invention, characterized in that it comprises the following steps: 1) Using field bean seeds; 2) Grinding the field bean seeds by means of a stone mill, followed by separating the obtained ground material into two fractions referred to as light and heavy by means of an ascending air flow, followed by a second grinding of the heavy fraction with a knife mill; 3) Finally grinding the heavy fraction by means of a roller mill to obtain a flour; 4) Suspending the flour in an aqueous solvent with a pH of between 6 and 8, preferably 7; 5) Removing the dry matter fractions from the suspension by centrifugation and obtaining a liquid fraction; 6) Isolating by precipitation by heating at the isoelectric pH of the field bean proteins contained in the liquid fraction; 7) Diluting the field bean proteins previously obtained to 15-20% by weight of dry matter and neutralizing the pH between 5.5 and 6.5, preferably 6.5, to obtain the field bean protein composition; 8) Drying the field bean protein composition

“Stone mill” is understood to mean a system made up of two superimposed stone cylinders leaving a space equal to the size of the seed. One of the cylinders is static, while the other is rotating. The seeds are inserted between these two cylinders, and their relative movement imposes physical stress on these seeds.

“Knife mill” should be understood to mean a system consisting of a chamber equipped with an upper inlet for inserting the seeds, several knives arranged on a shaft intended to rotate them inside said chamber and a lower outlet equipped with a sieve to let out only the seeds with a desired particle size.

The first step consists of using field bean seeds. These seeds still comprise their protective external fibers, also referred to as hulls. The seeds may then undergo a pre-treatment which can comprise steps of cleaning, sieving (for example, for separating seeds from stones), soaking, bleaching, toasting. Preferably, if bleaching is performed, the heat treatment scale will be 3 minutes at 80° C. Nonlimiting examples of varieties are Tiffany, FFS or YYY. Preferentially, field bean seed varieties with a naturally low tannin and/or polyphenol content, such as the Organdi variety, will be used. Such varieties are known and can be obtained by varietal crossing and/or genetic modification.

The second step relates to the most effective possible separation of the external fibers and the cotyledons. It begins with a first grinding of the field bean seeds using a stone mill. A specific, particularly appropriate example of such a stone mill is, for example, marketed by the company Alma®. As previously disclosed, the seed is inserted into a space formed by two stone discs, one of which is rotating. The applicant has noticed that this technique is particularly interesting since it produces a highly effective separation of the external fibers and the cotyledons of the seeds. Preferably, the inter-disc space is adjusted between 0.4 and 0.6 mm.

The obtained ground material is then subjected to a counter-current ascending air flow. The various solid particles are classified according to their density. Typically, after equilibrium, two fractions are obtained: a light fraction containing mostly the external fibers or hulls and a “heavy” fraction containing mostly the cotyledons. A specific, particularly appropriate example of an adequate apparatus is for example the MZMZ 1-40 marketed by the company Hosokawa-Alpine®.

The heavy fraction, enriched in cotyledons, is then ground using a knife mill. A specific, particularly appropriate example of such a knife mill is for example the SM300 marketed by the company Retsch®.

The succession of the three operations cited hereinbefore in the second step aims to separate very finely the external fibers and the cotyledons, avoiding damaging these two parts and mixing them. The methods of the background art are either too simplistic, and do not manage to effectively separate the external fibers, or are complicated and thus difficult to operate from an industrial viewpoint. The method disclosed for example in “Technological-scale dehulling process to improve the nutritional value of faba beans” (Meijer & al., in Animal Feed Science and Technology, 46, 1994) includes two grinding steps, two filtering steps and one turbo-separation (by an ascending air flow). This method makes it possible to obtain a cotyledon fraction that still contains 1.2% of external fibers in the cotyledons. Our invention simplifies the method (two grinding steps using types of mills with different technologies, with a turbo-separation between the two grinding steps) and makes it possible to reduce the external fiber content to a value of 1%, or less.

The third step aims to reduce the particle size of the heavy fraction enriched with cotyledons by grinding same using a roller mill. A specific, particularly appropriate example of such a roller mill is, for example, the MLU 202 marketed by the company Bühler®. It is used herein in order to reduce the overall particle size of the flour, in order to obtain a uniform, sufficiently fine powder so as to facilitate the following step 4. The preferred particle size is between 200 and 400 microns, preferentially 300 microns. In order to measure this particle size, a laser particle size analyzer is preferably used, although any method is possible, such as sieving.

Alternatively, the step of reducing the particle size of the heavy fraction enriched with cotyledons can be carried out in the presence of aqueous solvent, preferentially water. In this case, the fourth step below is merged with the third step which are then performed concomitantly.

The fourth step aims to place the powder obtained in the preceding third step in suspension in an aqueous solvent, preferentially in water. The aim here is to perform a selective extraction of certain components, mostly the proteins as well as the salts and the sugars, by solubilizing them. The pH of the solution is advantageously rectified towards a neutral pH in order to limit the solubilization of tannins and polyphenols as much as possible. This pH rectification can be carried out before and/or after suspending the powder in the aqueous solvent.

The aqueous solvent is preferentially water. The latter may, nevertheless, contain additives, for example with compounds that make it possible to facilitate the solubilization. The pH of the aqueous solvent is adjusted between 6 and 8, preferably 7. Any acidic or basic reagent such as soda, lime, citric or hydrochloric acid is possible, but potash and ascorbic acid are preferred. The temperature is adjusted between 2° C. and 30° C., preferentially between 10° C. and 30° C., preferentially between 15° C. and 25° C., even more preferentially at 20° C. This temperature is controlled throughout the entire extraction reaction.

The powder obtained is diluted in order to obtain a suspension between 5% and 25%, preferentially between 5% and 15%, preferentially between 7% and 13%, even more preferentially between 9% and 11%, the most preferred being 10%, the percentage being expressed as weight of powder by total weight of the water/powder suspension. The suspension is stirred using any apparatus known to a skilled person, for example a vat provided with a stirrer, provided with blades, marine propellers or any equipment that allows effective stirring. The extraction time, preferentially while stirring, is between 5 and 25 minutes, preferentially between 10 and 20 minutes, even more preferentially 15 minutes.

The fifth step aims to separate by centrifugation the soluble fraction and the solid fraction obtained during the fourth step. The preferred industrial principle can be found in patent application EP1400537, which is incorporated herein by reference. The principle of this method is to start by using a hydrocyclone in order to extract a fraction enriched in starch, then to use a horizontal decanter in order to extract a fraction enriched in internal fibers. Nevertheless, it is possible to use an industrial centrifuge which extracts a fraction enriched with starch and internal fibers. In every case, solid fractions and a liquid fraction that concentrates most of the proteins are obtained.

The sixth step aims to acidify to the isoelectric pH of the field bean proteins, around 4.5, and then to subject the solution to heating in order to coagulate the proteins referred to as globulins, which are separated by centrifugation.

The acidification is carried out to a pH between 4 and 5, preferentially 4.5. This is preferentially done with hydrochloric acid at about 7% by weight, but all types of acids, mineral or organic, can be used such as citric acid. Even more preferably, the use of pure ascorbic acid or ascorbic acid in combination with another mineral or organic acid is also possible. The use of ascorbic acid to acidify helps improve the final coloring. Any heating means is then possible, for example by means of a stirred vat provided with a double shell and/or coil or an in-line steam-injection cooker (“jet cooker”). The heating temperature is advantageously between 45° C. and 75° C., preferentially between 50° C. and 70° C., even more preferentially between 55° C. and 65° C., the most preferred being 60° C. The heating time is advantageously between 5 minutes and 25 minutes, preferentially between 10 and 20 minutes, the most preferred being 10 minutes.

The protein composition, mostly globulin, coagulates and precipitates within the solution. It is separated by any centrifugation technique, such as for example, the Flottwegg® Sedicanter. The residual solution obtained concentrates sugars, salts and albumins, it is referred to as field bean solubles. It is processed separately, preferentially evaporated and/or dried.

It should be noted that the background art of field bean protein extraction exclusively teaches isoelectric precipitation, without heating. The combination of the two steps according to the invention makes it possible to obtain the isolate according to the invention, but also to obtain field bean solubles (name of the supernatant obtained after precipitation and centrifugation) which are temperature-stable. Indeed, the field bean solubles obtained by isoelectric precipitation when they are exposed to a high temperature, for example in an evaporator, precipitate. This precipitation is a major drawback since is leads to soiling of industrial facilities.

Conversely, the combination of isoelectric precipitation with controlled heating proposed by the invention makes it possible to obtain:
a floc of coagulated proteins, resulting after the required treatment in the product claimed in the present application, and
residual solubles containing among others soluble proteins (albumins), salts and sugars

The second fraction can typically be reused in the fermentation and/or animal nutrition industries. For this purpose, it should be concentrated in order to be stabilized in bacteriological terms. For this purpose, an operation for concentration by evaporation under vacuum is conventional, carried out by means of a second heating step distinct from the one that allowed the coagulation of the floc. During this operation, and in the case of simple isoelectric precipitation during floc/soluble separation, a deposit of coagulated proteins builds up in the evaporator.

In a seventh step, the protein composition is then diluted to around 15-20% by weight of dry matter and neutralized to a pH between 5.5 and 6.5, preferentially 6.5, by means of any basic agent, preferentially potash at 20% by weight.

The protein composition can then undergo a thermal treatment, preferentially at a temperature of 135° C. by direct steam injection through a nozzle and flash vacuum cooling to 65° C.

The protein composition obtained can be used directly for example by being hydrolyzed by a protease or else texturized by an extruder.

In an eighth step, the protein composition according to the invention is dried. The preferred drying mode is atomization, in particular using a multiple-effect atomizer. The typical parameters are an input temperature of 200° C. and a vapor temperature of 85-90° C.

According to a final aspect, the industrial uses, in particular in human or animal nutrition, in cosmetics, in pharmacy, of the field bean protein isolate according to the invention are proposed. The protein composition according to the invention allows in particular an easy use in protein enrichment in bakery/pastry applications. The high protein content and the amino acid profile thereof allow a beneficial enrichment for the consumer, its low solubility enables the aqueous interactions to be limited and thus the disturbances within the dough or the dough pieces.

Within human food applications, the protein composition according to the invention is particularly suitable for dairy applications.

More particularly and preferably, the invention relates to the application of the field bean isolate in nutritional formulations such as:
beverages, particularly via mixtures of powders to be reconstituted, particularly for dietary nutrition (sports, slimming), ready-to-drink beverages for dietary or clinical nutrition, liquids (enteral beverages or bags) for clinical nutrition, plant beverages,
fermented milks such as yoghurts (blended, Greek, drinkable, etc.)
plant creams (such as coffee creamer or whitener), dessert creams, frozen desserts or sorbets.
biscuits, muffins, pancakes, nutritional bars (intended for specialized nutrition for slimming or for athletes), bread, particularly high-protein gluten-free bread, high-protein cereals, obtained by extrusion cooking (“crisps” for inclusion, breakfast cereals, snacks),
cheese,
meat analogues, fish analogues, sauces, in particular mayonnaise.

The nutritional formulations according to the invention may further comprise other ingredients that may modify the chemical, physical, hedonic or processing characteristics of the products or serve as pharmaceutical or complementary nutritional components when used for a certain target population. Many of these optional ingredients are known or otherwise suitable for use in other food products and may also be used in the nutritional formulations according to the invention, provided that these optional ingredients are safe and effective for oral administration and are compatible with the other essential ingredients of the selected product. Non-limiting examples of such optional ingredients comprise preservatives, antioxidants, emulsifying agents, buffering agents, pharmaceutical active agents, additional nutrients, colorants, flavors, thickening agents and stabilizers, etc. The powdered or liquid nutritional formulations may further comprise vitamins or nutrients such as vitamin A, vitamin E, vitamin K, thiamine, riboflavin, pyridoxine, vitamin B12, carotenoids, niacin, folic acid, pantothenic acid, biotin, vitamin C, choline, inositol, their salts and derivatives, and combinations thereof. The powdered or liquid nutritional formulations may further comprise minerals, such as phosphorus, magnesium, iron, zinc, manganese, copper, sodium, potassium, molybdenum, chromium, selenium, chloride, and combinations thereof. The powdered or liquid nutritional formulations may also comprise one or more masking agents to reduce, for example, bitter flavors in reconstituted powders. Suitable masking agents comprise natural and artificial sweeteners, sodium sources such as sodium chloride, and hydrocolloids such as guar gum, xanthan gum, carrageenan, and combinations thereof. The amount of masking agent in the powdered nutritional formulation may vary depending on the particular masking agent selected, the other ingredients in the formulation, and other formulation or target product variables.

Said invention will in particular be better understood from reading the following examples.

### EXAMPLES

### Example 1: Comparison of Traditional and Conventional Methods for Dehulling the External Fibers

A single batch of field bean seeds of the Tiffany variety is processed to separate the external fibers and the cotyledons. To do so, two methods are used.

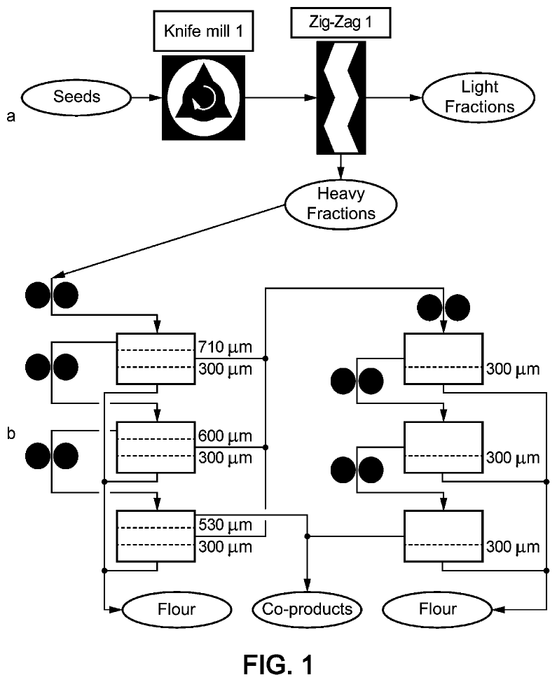

Method of the background art: The seeds are first processed using a knife mill (SM300, Retsch®) with a rotation speed of 700 rpm. The ground material is then processed by turbo-separation using a so-called “zig-zag” system (MZM 1-40, Hosokawa-Alpine®). The air speed is 4.0 m·s⁻¹ (23 m³·h⁻¹). At the end a light fraction containing the external fibers and a heavy fraction containing the cotyledons are obtained. The heavy fraction is then ground using a roller mill (MLU 202, Bühler®). At the end a flour is obtained in which the particle size is less than 300 μm. The method is shown schematically in FIG. 1.

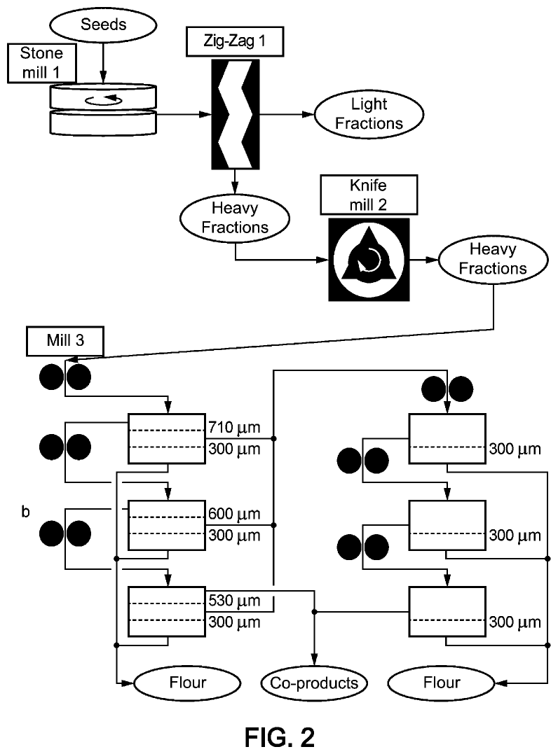

Improved method according to the invention: The seeds are first processed using a stone mill (Alma®). The ground material is then processed by turbo-separation using a so-called “zig-zag” system (MZM 1-40, Hosokawa-Alpine®). The air speed is 4.0 m·s⁻¹ (23 m³·h⁻¹). At the end a light fraction containing the external fibers and a heavy fraction containing the cotyledons are obtained. The heavy fraction is then processed using a knife mill (SM300, Retsch®) with a rotation speed of 700 RPM, the outlet of which is fitted with a 6 mm screen. The heavy fraction is then ground using a roller mill (MLU 202, Bühler®). At the end a flour is obtained in which the particle size is less than 300 μm. The method is schematically shown in FIG. 2.

A manual separation is carried out of the residual external fibers (or hulls) in the heavy fraction obtained according to the two methods of the background art and according to the invention disclosed previously. This consists in taking a 200 g sample of the fraction, and then manually separating the external fibers still present. These are then weighed (Weight=m). The percentage of residual external fibers is given by the following calculation: (m/200)*100

For the method according to the background art, the percentage is 1.7%. For the method according to the invention, this percentage is reduced to 0.9%.

### Example 2: Production of a Protein Composition According to the Invention

75 kg of field bean flour is prepared using the improved method according to the invention disclosed in paragraph [0063] hereinbefore. This flour is placed in suspension at 10% by weight of dry matter in drinking water at 20° C. The pH is adjusted to 7 by adding potash. Homogenization is carried out during 15 minutes, also at 20° C. The solution is then sent to a Flottweg Sedicanter decanter (bowl speed: 60% or 4657 rpm (about 3500 g), screw speed at 60% for a Vr=18.8, pipette for the supernatant (overflow) at 140 mm, supply at 1 m³/h) and the liquid supernatant containing the proteins is recovered.

This supernatant is acidified to pH 4.5 by addition of hydrochloric acid to about 7% by weight. It is heated to 60° C. by injecting steam into a double shell of the vat, where homogenization is carried out during 15 minutes. The Flottweg Sedicanter is used a second time (bowl speed at 60%, or 4657 rpm (about 3,500 g), screw speed at 10% for Vr=3.5 up to 40% (Vr=12.6), pipette for overflow at 140 mm at the start until 137, supply at 700 l/h) but this time in order to recover the sediment that contains the coagulated proteins.

The sediment is diluted to about 15-20% by weight of dry matter and neutralized to pH 6.5 by adding potash to 20%. A heat treatment is performed at 135° C. by means of a nozzle and flash vacuum cooling to 65° C. The product is finally atomized (input temperature of 200° C. and vapor temperature of 85-90° C.)

The protein extraction yield from the flour is 72.5%. The protein obtained is named “Protein composition according to the invention”

### Example 3: Production of a Protein Composition According to the Background Art

For this example, we use the teaching of “Textural properties of legume protein isolate and polysaccharide gels” (Makri & al., Journal of the Science of Food and Agriculture, 86, 1855-1862.) cited in the thesis “THE EFFECT OF GENOTYPE AND THE ENVIRONMENT ON THE PHYSICOCHEMICAL AND FUNCTIONAL ATTRIBUTES OF FABA BEAN PROTEIN ISOLATES” (Shingha, 2015). Briefly, 350-400 g of flour is dispersed in distilled water (1:10, w/v) and adjusted to pH 9.5 with 1M NaOH, stirred (500 rpm) at 21-23° C. for 40 min, then centrifuged (1,600×g, 20 min, 4° C.). The supernatant is taken and diluted in distilled water (1:5, w/v), stirred and centrifuged (1,600×g, 20 min, 4° C.). The pH of the supernatant is adjusted to 4.5 with 1M HCl, and centrifuged (1,600×g, 20 min, 4° C.). The supernatant is rediluted in deionized water, adjusted to pH 7.0 with 1M NaOH, and lyophilized.

The protein extraction yield from the flour is 81.2%. The protein obtained is named “Protein composition according to the background art”

### Example 4: Comparison of Functionalities and Analyses

The various compositions obtained by virtue of examples 2 and 3 are compared from an analytical (dry matter and protein content) and functional (solubility according to test A) point of view. A commercial field bean protein composition, FAVA BEAN PROTEIN ISOLATE 85% by the company YANTAI T, FULL BIOTECH CO LTD (batch DFC021606181/C1377) is also acquired, which is representative of the field bean isolates available on the market. Table 1 hereunder summarizes these analyses.

TABLE 1

| | | | FAVA BEAN |
|---|---|---|---|
| | | | PROTEIN |
| | | | ISOLATE 85% |
| | Protein | Protein | by the company |
| | composition | composition | YANTAI T, FULL |
| | according to | according to | BIOTECH CO |
| | example 3 | example 2 | LTD (batch |
| | according to the | according to | DFC021606181/ |
| | background art | the invention | C1377) |
| Dry matter (in % | 94.2 | 93.5 | 92.9 |
| by weight) | | | |
| Protein content | 93.5 | 92.6 | 88.3 |
| (in protein % in | | | |
| the dry matter) | | | |
| Solubility pH 3 | 77.3 | 17.9 | 40.5 |
| (in %) | | | |
| Solubility pH 4 | 20.0 | 9.8 | 12.1 |
| (in %) | | | |
| Solubility pH 5 | 12.6 | 7.6 | 7.9 |
| (in %) | | | |
| Solubility pH 6 | 21.0 | 10.5 | 24.0 |
| (in %) | | | |
| Solubility pH 7 | 56.0 | 18.9 | 38.3 |
| (in %) | | | |
| Solubility pH 8 | 63.0 | 23.0 | 40.4 |
| (in %) | | | |
| Parameter L (of | 88 | 84 | |
| the Color L*a*b) | | | |

The Table shows the exceptionally low solubility of the protein composition according to the invention at pH levels above 7: it is well below 25%, while the protein compositions according to the background art exceed 35%.

The gelling power of the different isolates is also quantified using the protocol below:

1. Preparing an aqueous suspension by mixing water and isolate in order to obtain a final suspension titrating 15% in dry matter and at pH 7;
2. Placing the suspension in a rheometer with imposed stress equipped with a concentric cylinder model DHR 2 (TA, instruments);
3. Measuring the elastic modulus G′ and viscous modulus G″ by applying a temperature profile as follows:
a. Phase 1: heating from a temperature of 20° C. to a temperature of 80° C. in 10 minutes
b. Phase 2: stabilization at a temperature of 80° C. for 110 minutes
c. Phase 3: cooling of a temperature from 80° C. to a temperature of 20° C. in 30 minutes;

The results are as follows:

| | | | FAVA BEAN |
|---|---|---|---|
| | | | PROTEIN |
| | | | ISOLATE 85% |
| | Protein | Protein | by the company |
| | composition | composition | YANTAI T, FULL |
| | according to | according to | BIOTECH CO |
| | example 3 | example 2 | LTD (batch |
| | according to the | according to | DFC021606181/ |
| | background art | the invention | C1377) |
| G1 = G′ 20° C. | 148 | 593 | 34 |
| before thermal | | | |
| treatment | | | |
| G2 = G′ 80° C. | 241 | 1517 | 102 |
| after thermal | | | |
| treatment | | | |
| G3 = G′ 20° C. | 811 | 3498 | 439 |
| after thermal | | | |
| treatment | | | |
| Gelling power = | 663 | 2904 | 404 |
| G3 − G1 | | | |

It can be seen that the gelling power is 5 to 6 times higher than the isolates according to the background art.

### Example 5: Vegetarian Sausages

The bean isolate according to the invention and commercial pea isolate are compared in vegan recipes. The recipe is as follows:

| Weight (in g) | Sausage 1 | Sausage 2 | Sausage 3 |
|---|---|---|---|
| Drinking water | 509.9 | | |
| Crushed ice | 509.9 | | |
| Sunflower oil | 489.5 | | |
| Native potato starch (ROQUETTE) | 113.2 | | |
| Vital wheat gluten (ROQUETTE) | 102 | | |
| Egg white | 30.6 | | |
| Methyl cellulose | 20.4 | | |
| Salt | 20.4 | | |
| Tomato powder | 5.1 | | |
| Garlic | 4.1 | | |
| White pepper | 1 | | |
| Nutralys ® S85 | 193.7 | | |
| Nutralys ® F85 | | 193.7 | |
| Feverole Isolate | | | 193.7 |

The protocol for manufacturing the sausages is as follows:
Mixing water and crushed ice
Dispersing methyl cellulose in 60% of the water/ice mixture using a Kenwood Electronic KM231 (Britain). 5 min at maximum speed.
Adding protein to be tested and mix with a Kenwood Electronic KM231 (Britain). 10 min at maximum speed.
With maximum stirring, adding the oil and allowing the mixture to homogenize for another 10 minutes.
Adding the rest of the powdered ingredients and the remaining 40% of the water/ice mixture. Final stirring at maximum speed for 5 minutes.
Filling of 2 meters of artificial peelable cellulosic casings Viscofan (company DATSchaub, Thiais, France).
Cooking in an industrial oven (Bourgeois oven S2ON1—Serial number S2476057) for 1 hour at 100° C., with humidity controlled level 4.
The sausages are taken out of the oven and left to stabilize at room temperature
Artificial peelable cellulosic casings are removed by hand
Before analysis, the sausages are cooked in boiling drinking water without salt for 5 minutes and left at room temperature for 30 minutes.

The sausages obtained are compared with a rheometer TAXT2i (Stable Micro Systems, Texture Analyzer Model XT2i, Great Britain) and its software version 2.64.

A test called “slicing” or “cutting” is carried out to characterize the sausages, consisting of carrying out an action of separating the sausage in two parts with the help of the texture analyzer while measuring the force necessary. This test was performed using a Warner-Bratzler Shear with a complete penetration of 25 mm of the sausage and a minimum detection limit of 0.06 N. The maximum force at the breaking point is used to characterize.

The values obtained are as follows:

| | Maximum force |
|---|---|
| | (N) |
| Sausage 1 | 1.750 |
| Sausage 2 | 2.167 |
| Sausage 3 | 5.583 |

It can be seen that the force required to slice the sausage 3 is much greater than that required to slice the sausages obtained with commercial pea isolates. This result leads to the conclusion that the sausages obtained with the field bean isolate according to the invention are firmer.

### Example 6: Regular and Light Mayonnaise

We will demonstrate below the excellent results of our isolate according to the invention in the production of regular mayonnaise (called “full-fat”) and light mayonnaise (called “low-fat”).

The ingredients needed to make the mayonnaise recipes are as follows:

| | |
|---|---|
| “Full-fat” recipe | “Low-fat” recipe |

Ingredients for 1st phase

| | | |
|---|---|---|
| Drinking water | 10.58% | 53.78% |
| Mustard | 2.50% | 2.50% |
| Sucrose | 4.50% | 4.50% |
| NaCl | 1.00% | 1.00% |
| Protein isolate to be tested | 0.8 | 0% |
| Potassium sorbate | 0.12% | 0.12% |

Ingredients for 2nd phase (Dispersion in the oil)

| | | |
|---|---|---|
| Sunflower oil | 70.00% | 25.00% |
| PREGEFLO CH40 pregelatinized | | 4.00% |
| starch (ROQUETTE) | | |
| Xanthan gum | | 0.30% |

Ingredients for 3rd phase (acid)

| | | |
|---|---|---|
| White vinegar | 5.50% | 5.50% |
| Lemon juice | 2.50% | 2.50% |

Ingredients for 4th phase (oil)

| | |
|---|---|
| Sunflower oil | 2.50% |

The isolates to be tested are Nutralys® F85F by the company ROQUETTE, the field bean isolate according to the invention and aquafaba (“Aquafaba Powder” obtained from the company Vôr).

The manufacturing protocol is as follows:
Mixing the ingredients for the 1st phase during 1 min at speed 3 in a HOTMIX Pro Gastro (Manufacturer: MATFER-FLO, Model: 212502).
Adding the ingredients for the 2nd and 3rd phase for 1:30 min at speed 4 and 7 for Low Fat or adding the ingredients for 2nd phase for 2 min at speed 3 for Full Fat.
Adding the ingredients for the 3rd phase during 1 min at speed 3 for Full Fat.
Adding the ingredients for the 4th phase during 1 min at speed 3 for Full Fat.
Finishing the emulsion at speed 8 for Low Fat and 3 for Full Fat during 1 min.

The different mayonnaises obtained are compared using a TA.HDplus texture analyzer (presented in annex 1), allowing us to measure the parameters of firmness, consistency and cohesion. The firmness (g) corresponds to the force to be applied so that the geometry (cf. “extrusion ring backward” kit described hereunder) penetrates into the product, the consistency (g·sec) is a data item calculated according to the area under the curve of the firmness and the cohesion (g) corresponds to the force to be applied so that the geometry withdraws from the mayonnaise.

The texture analyzer is equipped with the “extrusion ring backward” kit which is made up of a disc screwed onto the apparatus and 3 plexiglass containers, which are filled with the mayonnaise. The acquisition is carried out using the Exponent software with the program designed to analyze mayonnaises. The geometry is lowered at 3 mm/s until it reaches the bottom of the container and it is raised at 5 mm/s. The software automatically draws a curve based on time making it possible to deduce the parameters thereof.

The entire implementation is clearly explained in the instruction manual.

The results for “low-fat” mayonnaises are as follows:

| | | Consistency | Cohesion |
|---|---|---|---|
| | Firmness | (g/sec) | (g) |
| Aquafaba | 461 | 12,361 | −594 |
| Nutralys F85F | 416 | 11,027 | −530 |
| Protein isolate according to | 468 | 12,343 | −611 |
| the invention | | | |
| Egg mayonnaise | 491 | 13,371 | −617 |

The results “full-fat” mayonnaises are as follows:

| | Firmness | Consistency | Cohesion |
|---|---|---|---|
| | (g) | (g/sec) | (g) |
| Nutralys F85F | 235 | 5,055 | −245 |
| Protein isolate according | 232 | 6,377 | −246 |
| to the invention | | | |
| Egg mayonnaise | 358 | 9,791 | −489 |

The results obtained show that the mayonnaises obtained with the field bean isolate according to the invention are characterized by excellent texture values for “low-fat” mayonnaises, superior to the pea isolate or aquafaba.

### Example 7: Plant Milk or “Milk Alternative”

Plant milk is made to evaluate the performance of our isolate according to the invention in this application.

The recipe is as follows:

| Ingredients | % |
|---|---|
| Water | 92.28 |
| Cane sugar | 2.80 |
| Sunflower oil | 1.50 |
| Gellan gum (Kelcogel HS-B) | 0.12 |
| Pea isolate according to the invention | 3.30 |

The preparation protocol is as follows:
Heating water to 70° C. and hydrating the protein isolate during 15 min with a Sylverson at 2,000 rpm
Adding the other ingredients except for the oil and mixing for 10 min
Heating the oil to 65° C. and adding under stirring at 6,000 rpm
UHT sterilization 142° C. for 5 sec
Homogenizing at 75° C. 2 stages (270 bars and 30 bars)
Cooling to 4°) C.

An analysis of the particle size distribution of the emulsified oil globules is performed using a Mastersizer particle size analyzer. The particle size parameters are as follows: D10=0.21 microns, D50=0.45 microns and D90=1.42 microns.

These results are excellent and clearly show an excellent emulsification of lipid globules, just like milk.

1-13. (canceled)

14. A field bean protein composition the color of which comprises a component L greater than 70, preferably greater than 75, even more preferentially greater than 80 according to the measurement L*a*b and the solubility according to the test A at a minimum pH of 7 is less than 25% of the total weight.

15. The protein composition according to claim 14, wherein the solubility thereof according to the test A at a minimum pH of 7 and a maximum pH of 8 is less than 25% of the total weight.

16. The protein composition according to claim 14, wherein the solubility thereof according to the test A at pH 3 is less than 25% of the total weight.

17. The protein composition according to claim 14, wherein its protein content is greater than 70% expressed as a weight percentage of protein on dry matter, preferentially greater than 80% by weight, even more preferentially greater than 90% by weight.

18. The protein composition according to claim 14, wherein it has a dry matter content greater than 80% by weight, preferentially greater than 85% by weight, even more preferentially greater than 90% by weight.

19. A method for the production of the protein composition according to claim 14, comprising the following steps:
1) Using field bean seeds;
2) Grinding the field bean seeds by means of a stone mill, followed by separating the obtained ground material into two fractions referred to as light and heavy by means of an ascending air flow, followed by second grinding of the heavy fraction with a knife mill;
3) Finally grinding the heavy fraction by means of a roller mill to obtain a flour;
4) Suspending the flour in an aqueous solvent, the pH of which is between 6 and 8, preferentially 7;
5) Removing the solid fractions from the suspension by centrifugation and obtaining a liquid fraction;
6) Isolating by precipitation by heating at the isoelectric pH of the field bean proteins contained in the liquid fraction;
7) Diluting the field bean proteins previously obtained to 15-20% by weight of dry matter and neutralizing the pH between 5.5 and 6.5, preferentially 6.5, to obtain the field bean protein composition;
8) Drying the field bean protein composition.

20. The method according to claim 19, wherein the average particle size of the flour obtained in step 3 is between 200 and 400 microns, preferentially 300 microns.

21. The method according to claim 19, wherein the temperature of the aqueous solvent of step 4 is adjusted between 2° C. and 30° C., preferentially between 10° C. and 30° C., preferentially between 15° C. and 25° C., even more preferentially to 20° C.

22. The method according to claim 19, wherein the acidification of the liquid fraction during step 6 is carried out at a pH between 4 and 5, preferentially 4.5.

23. The method according to claim 19, wherein the pH of the liquid fraction during step 6 is adjusted by means of ascorbic acid.

24. The method according to claim 19, wherein the heating temperature of step 6 is between 45° C. and 75° C., preferentially between 50° C. and 70° C., even more preferentially between 55° C. and 65° C., the most preferred being 60° C. and the heating time of step 6 is between 5 minutes and 25 minutes, preferentially between 10 and 20 minutes, the most preferred being 10 minutes.

25. The method according to claim 19, wherein that step 7 also contains a thermal treatment, preferentially at a temperature of 135° C. by direct steam injection through a nozzle and flash vacuum cooling to 65° C.

26. An industrial use, in particular in human or animal nutrition, in cosmetics, in pharmacy, of the field bean protein composition, the color of which comprises a component L greater than 70, preferably greater than 75, even more preferentially greater than 80 according to the measurement L*a*b and the solubility according to the test A at a minimum pH of 7 is less than 25% of the total weight or obtained by a method according to claim 19.
